(19) United States
(12) Patent Application Publication
(10) Pub. No.: US 2024/0269754 A1
(43) Pub. Date: Aug. 15, 2024

(54) BORING TOOL

(71) Applicant: Apex Brands, Inc., Apex, NC (US)

(72) Inventor: Laverne Royal Durfee, Statesville, NC (US)

(21) Appl. No.: 18/570,258

(22) PCT Filed: Jun. 17, 2022
(86) PCT No.: PCT/US2022/033944

§ 371 Date: Dec. 14, 2023

Related U.S. Application Data
(60) Provisional application No. 63/212,322, filed on Jun. 18, 2021.
(60) Provisional application No. 63/203,561, filed on Jul. 27, 2021.

(51) Int. Cl. B23B 51/00; B23P 15/28

(52) U.S. Cl. CPC B23B 51/0095; B23P 15/28

(57) ABSTRACT

A boring tool includes a coupling portion, a shank, and a cutting portion. The shank further includes a torsion release neck, having a smaller diameter cross section than a first end of the shank and a second end of the shank, a first transition to the first end of the shank, and a second transition to the second end of the shank. A torsion release neck has a lower polar moment of inertia than other portions of the boring tool so that it may guide torsional loading and shear stresses in the boring tool away from the cutting and coupling portions to improve the durability of the boring tool as a whole.

### TECHNICAL FIELD

Example embodiments generally relate to power equipment and, more particularly, relate to improvements for a boring tool.

### BACKGROUND

Boring tools are commonly used in both commercial and private settings to bore holes of various sizes and purposes into lumber or other working media. Typically employed in a construction setting, boring tools are most often driven by a driving device with an electric motor that applies torque to a boring tool to rotate it at relatively high speeds. The tool includes a cutting portion that engages lumber or another medium in order to bore a hole in the medium as the tool is rotated at high speed and pressed into the medium to a desired bore depth.

Given that boring tools may be employed to bore holes in media of various types, the boring tool can include a different shank and/or a different cutting portion for its different applications. In circumstances where the quality of the bore is not as important, and where shallower holes may be desired, spade bits are a popular choice. Spade bits commonly have a cutting portion that is relatively broad and flat with three cutting components that perform a boring operation. On the other hand, auger bits are a good choice to use in circumstances where cleaner bores and/or deeper bores are desired. Auger bits commonly have a helical cutting portion where the entire helix is utilized in a boring operation. Additionally, spade bits are typically cheaper to manufacture and cheaper for consumers to purchase than auger bits. Both spade bits and auger bits are examples of common boring tools that can be used with a driving device to bore holes in a working medium.

The nature of boring a hole with a boring tool requires the driving device to apply torque to the boring tool to induce a rotational motion in the boring tool. As a result of the electric motor of the driving device applying high levels of torque, and depending on the working medium, boring tools are often subjected to high torsional loads and high shear stresses. Thus, creating a boring tool that can better distribute the torsional loads experienced during operation may allow for a more favorable overall experience than other boring tools could produce, as well as improve the longevity of the boring tool.

### BRIEF SUMMARY OF SOME EXAMPLES

Some example embodiments may provide for a boring tool. The boring tool may include a coupling portion, a shank and a cutting portion. A shank may include a first end proximate to the coupling portion, a second end proximate to the cutting portion, a torsion release neck disposed between the first end and the second end, a first transition between the first end and the torsion release neck, and a second transition between the second end and the torsion release neck. A coupling portion may be configured to be operably coupled to a driving device to rotate the boring tool.

In another example embodiment, a method of forming a boring tool may be provided. The method may include machining the boring tool from a metallic bar stock such that the boring tool includes a coupling portion, a shank, and a cutting portion. The method further includes machining the boring tool from the metallic bar stock such that the shank includes a first end proximate to the coupling portion, a second end proximate to the cutting portion, a torsion release neck disposed between the first end and the second end, a first transition between the first end and the torsion release neck, and a second transition between the second end and the torsion release neck, where the coupling portion is configured to be operably coupled to a driving device to rotate the boring tool.

### BRIEF DESCRIPTION OF THE SEVERAL VIEWS OF THE DRAWING(S)

Having thus described some example embodiments in general terms, reference will now be made to the accompanying drawings, which are not necessarily drawn to scale, and wherein:

FIG. 1 illustrates a block diagram of a boring tool according to an example embodiment;

FIG. 2 illustrates a side view of a boring tool in accordance with an example embodiment;

FIG. 3A illustrates a side view of a boring tool in accordance with an example embodiment;

FIG. 3B illustrates a side view of a boring tool in accordance with an example embodiment;

FIG. 4 illustrates a perspective view of a portion of a shank of a boring tool in accordance with an example embodiment;

FIG. 5 illustrates a perspective view of a portion of a shank of a boring tool in accordance with an example embodiment;

FIG. 6 illustrates a perspective view of a portion of a shank of a boring tool in accordance with an example embodiment;

FIG. 7 illustrates a perspective view of a portion of a shank of a boring tool in accordance with an example embodiment; and

FIG. 8 illustrates a flowchart diagram of a method of machining a boring tool in accordance with an example embodiment.

### DETAILED DESCRIPTION

Some example embodiments now will be described more fully hereinafter with reference to the accompanying drawings, in which some, but not all example embodiments are shown. Indeed, the examples described and pictured herein should not be construed as being limiting as to the scope, applicability or configuration of the present disclosure. Rather, these example embodiments are provided so that this disclosure will satisfy applicable legal requirements. Like reference numerals refer to like elements throughout. Furthermore, as used herein, the term “or” is to be interpreted as a logical operator that results in true whenever one or more of its operands are true. As used herein, operable coupling should be understood to relate to direct or indirect connection that, in either case, enables functional interconnection of components that are operably coupled to each other.

Some example embodiments may provide a boring tool constructed from a metallic material and having a coupling portion, a shank, and a cutting portion. The shank may further have a torsion release neck which may be designed to concentrate torsional load forces. The torsion release neck may be biased closer to one end of the shank than another. The torsion release neck may have a smaller diameter than the other portions of the shank. Therefore, the torsion release neck may act as a concentration point for torsional loading forces and shear stresses in the boring tool. As will be discussed below, the concentration of torsional load forces and shear stresses away from the cutting portion of the boring tool allows for the boring tool to have improved boring performance and overall improved durability. Additionally, the reduced diameter of the torsion release neck acts as a cost cutting measure during manufacturing as it requires less time to machine than reducing the diameter of the entire shank. Other improvements may also be possible, and the improvements can be made completely independent of each other, or in combination with each other in any desirable configuration. Accordingly, the operability and utility of the boring tool may be enhanced or otherwise facilitated while strengthening the boring tool.

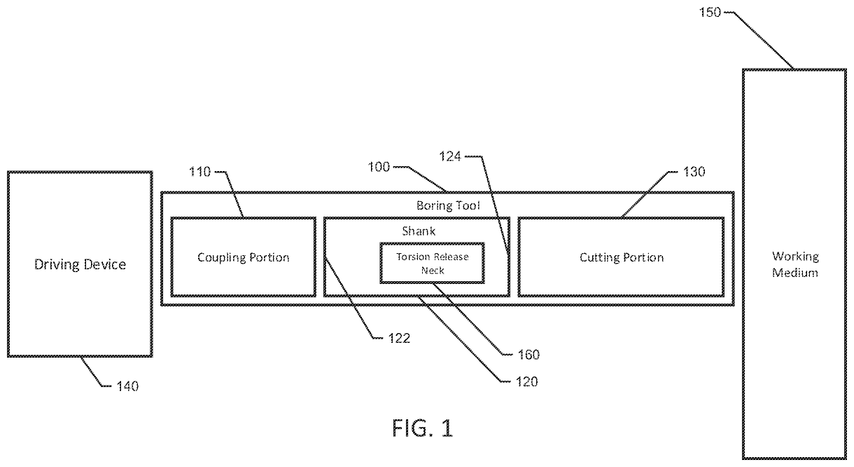

FIG. 1 illustrates a block diagram of a boring tool 100 according to an example embodiment. As shown in FIG. 1, the boring tool 100 may include a coupling portion 110, a shank 120, and a cutting portion 130. The coupling portion 110 may be configured to operably couple the boring tool 100 to a driving device 140. In this regard, the coupling portion 110 may be a part of the boring tool 100 that actively receives a driving force. In some embodiments, the driving device 140 may be a handheld power tool such as a drill or an impact driver. The coupling portion 110 of the boring tool 100 may therefore be configured to assist with translating torque from the driving device 140 into rotational motion of the boring tool 100. The driving device 140 may also be configured to be securely operably coupled with the coupling portion 110 such that the boring tool 100 doesn't become uncoupled from the driving device 140 due to forces exerted on the boring tool 100 by a working medium 150. In some embodiments, the working medium 150 may be wood. In some embodiments, the coupling portion 110 of the boring tool 100 may be configured to have a non-circular outer surface to facilitate translating torque from the driving device 140 to the rest of the boring tool 100. For example, the coupling portion 110 may have a hexagonally shaped cross section to facilitate engagement with a chuck of a driving device 140 such as a drill.

The shank 120 may operably couple the coupling portion 110 to the cutting portion 130. Thus, the shank 120, may assist with translating torque from the driving device 140 into rotational motion of the cutting portion 130. The coupling portion 110 may be operably coupled to a first end 122 of the shank 120 and the cutting portion 130 may be operably coupled to a second end 124 of the shank 120. Therefore, the shank 120 may be subject to high torsional loading due to the shank 120 forming a connection between the coupling portion 110 and the cutting portion 130, both of which may experience opposing forces while the boring tool 100 is in use. In this regard, the driving device 140 may exert a torque on the coupling portion 110 and the working medium 150 may exert a frictional force against the cutting portion 130 that may oppose the direction of rotation of the boring tool 100. Thus, these opposing forces may be naturally distributed throughout the boring tool 100. The cutting portion 130 may be the part of the boring tool 100 that is configured to bore a hole in the working medium 150. The cutting portion 130 may include a plurality of cutting structures which will be discussed in greater detail below in reference to later figures.

The shank 120 of an example embodiment may further include a torsion release neck 160. The torsion release neck 160 may be a neck in the shank 120 which may have a smaller diameter than both the first end 122 of the shank 120 and the second end 124 of the shank 120. Since boring tools are often made from a single metallic bar stock, machining the torsion release neck 160 to have a smaller diameter than the first end 122 of the shank 120 and the second end 124 of the shank 120, may require less time and machining than reducing the diameter of the entire shank 120. Thus, the boring tool 100 may be cheaper to produce and therefore it may be cheaper for a consumer to purchase as well. Further, allowing other portions of the shank 120 to have a larger diameter than the torsion release neck 160 may ensure that the boring tool 100 exhibits adequate levels of rigidity while in use. In this regard, the boring tool 100 may bore straighter holes and may be less likely to warp or change shape over longer periods of time.

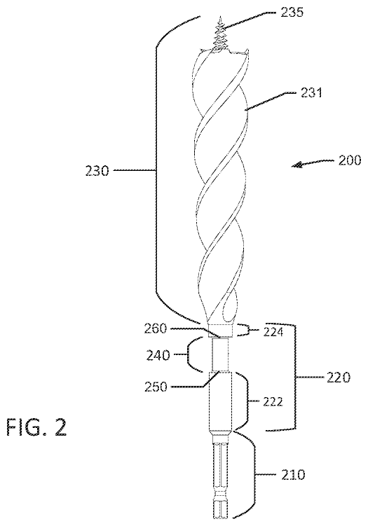

Additionally, as a result of the torsion release neck 160 having a smaller diameter than the first end 122 of the shank 120 and the second end 124 of the shank 120, the torsion release neck 160 may also have a lower mathematical value for its polar moment of inertia than other portions of the boring tool 100. In this regard, the torsion release neck 160 may be the part of the boring tool 100 that is least resistant to torsional loading. As such, the torsion release neck 160 may help preserve the functionality of both the cutting portion 130 and the coupling portion 110 of the boring tool 100 by reducing the amount of torsional shock felt at these respective portions. Furthermore, due to the inverse mathematical relationship between polar moment of inertia and shear stress, the torsion release neck 160 of the shank 120 may reduce the magnitude of the shear stresses that the boring tool 100 experiences at the cutting portion 130 and the coupling portion 110. In this regard, the torsion release neck 160 may assist with reducing the likelihood of the boring tool 100 experiencing material failures (i.e. cracking or chipping) at either the coupling portion 110 or the cutting portion 130. Thus, the boring tool 100 as a whole may exhibit improved durability and better boring performance as a result of the torsion release neck 160 reducing torsional loading and shear stresses at the cutting portion 130 and the coupling portion 110. Various example embodiments will now be described in reference to FIGS. 2-7, which illustrate some of these example embodiments.

In this regard, FIG. 2 illustrates a side view of a boring tool 200 in accordance with an example embodiment. In this embodiment, the boring tool 200 may resemble an auger bit. The boring tool 200 may include a coupling portion 210, a shank 220, a cutting portion 230 and a torsion release neck 240. The shank 220 may further comprise a first end 222, disposed proximate to the coupling portion 210, and a second end 224, disposed proximate to the cutting portion 230. In some embodiments the cutting portion 230 may include a helical cutting surface 231 in the cutting portion 230. In this regard, the helical cutting surface 231 of the cutting portion 230 may assist with removing debris from a hole as it is bored via the rotational motion of the boring tool 200. The helical cutting surface 231 of the boring tool 200 may also have advantages in the overall finish of a hole after it is bored. In this regard, the helical cutting surface 231 may yield a cleaner finish than other cutting portion 230 designs. In some embodiments, the cutting portion 230 may also include a feed screw 235 disposed at the tip of the boring tool 200. The feed screw 235 may assist the boring tool 200 by providing feed motion to help drive the boring tool 200 deeper into a working medium 150. In this regard, the boring tool 200 that resembles an auger bit may be better suited for producing deeper bores than other embodiments.

Disposed between the first end 222 of the shank 220 and the torsion release neck 240 may be a first transition 250, and disposed between the second end 224 of the shank 220 and the torsion release neck 240 may be a second transition 260. In this regard, the first transition 250 and the second transition 260 may operably couple the torsion release neck 240 to the shank 220 at the first end 222 of the shank 220 and the second end 224 of the shank 220, respectively. The first and second transitions (250, 260, respectively) may reduce stress concentrations at connection surfaces of the torsion release neck 240 and the shank 220, and therefore strengthen these connections. In this regard, the first transition 250 and the second transition 260 may reduce the potential for the connection surfaces of the torsion neck 240 and the shank 220 to become points of failure for the boring tool 200. The first transition 250 and the second transition 260 may include a plurality of structures which will be discussed in greater detail below in reference to later figures.

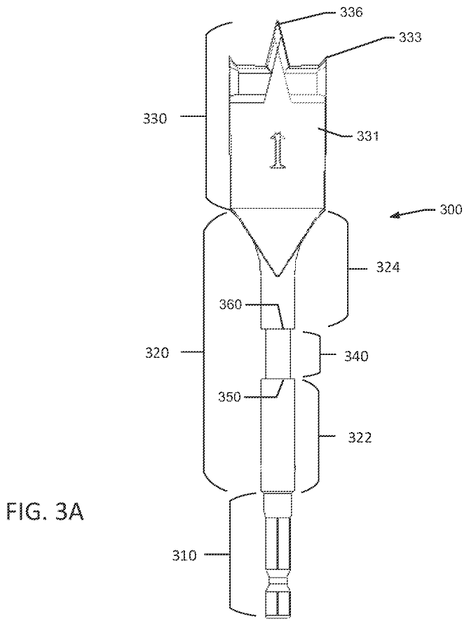

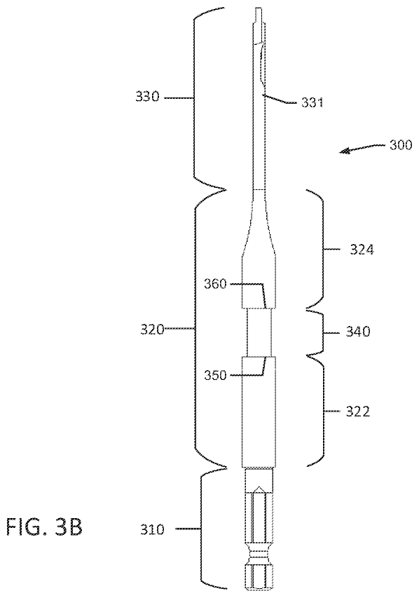

FIGS. 3A and 3B illustrate different side views of a boring tool 300 in accordance with an example embodiment. In this embodiment, the boring tool 300 may resemble a spade bit. The boring tool 300 may include a coupling portion 310, a shank 320, a cutting portion 330 and a torsion release neck 340. The shank 320 may further comprise a first end 322, disposed towards the coupling portion 310, and a second end 324, disposed towards the cutting portion 330. In some embodiments the cutting portion 330 may include a planar cutting surface 331. Disposed at the corners of the planar cutting surface 331 there may be cutting teeth 333. Additionally, there may be a brad point 336 centrally disposed at the edge of the planar cutting surface 331. In this regard, the cutting teeth 333 may enhance the boring operation via the rotational motion of the boring tool 300. The brad point 336 may assist with aligning the boring tool 300 with the center of the bore, and keeping the boring tool 300 in a straight line while it is in use. The planar cutting surface 331 may be advantageous to use for shallower boring operations when compared to other cutting portion 330 designs.

Disposed between the first end 322 of the shank 320 and the torsion release neck 340 may be a first transition 350, and disposed between the second end 324 of the shank 320 and the torsion release neck 340 may be a second transition 360. In this regard, the first transition 350 and the second transition 360 may operably couple the torsion release neck 340 to the shank 320 at the first end 322 of the shank 320 and the second end 324 of the shank 320, respectively. The first and second transitions (350, 360, respectively) may reduce stress concentrations at connection surfaces of the torsion release neck 340 and the shank 320, and therefore strengthen these connections. In this regard, the first transition 350 and the second transition 360 may reduce the potential for the connection surfaces of the torsion neck 340 and the shank 320 to become points of failure for the boring tool 300. The first transition 350 and the second transition 360 may include a plurality of structures which will be discussed in greater detail below in reference to later figures.

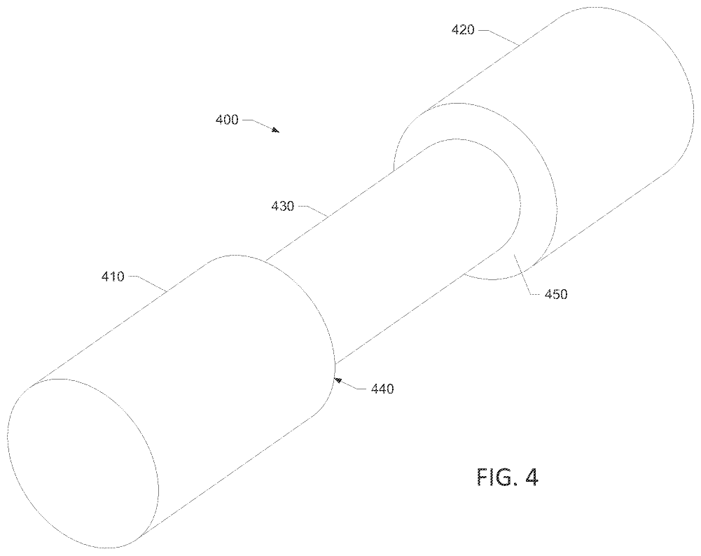

FIG. 4 illustrates a perspective view of a portion of a shank 400 of a boring tool (100, 200, 300) in accordance with an example embodiment. The shank 400 may further comprise a first end 410, a second end 420, a torsion release neck 430, a first transition 440 and a second transition 450. In some embodiments, the torsion release neck 430 may have a diameter of greater than or equal to 65%, and less than or equal to 95%, of a diameter of the first end 410 and the second end 420 of the shank 400. In some other embodiments, the torsion release neck 430 may have a diameter of greater than or equal to 80%, and less than or equal to 90%, of a diameter of the first end 410 and the second end 420 of the shank 400. In some embodiments, the first transition 440 and second transition 450 may be right angle connections between the torsion release neck and the first end 410 and the second end 420, respectively. In some embodiments, the shank 400 may have a total axial length of between about 1 inch to about 5 inches, and the torsion release neck 430 may have an axial length of between about 0.5 inches to about 1.5 inches. In one example embodiment, the torsion release neck 430 may be about 18 mm (0.7 inches) long.

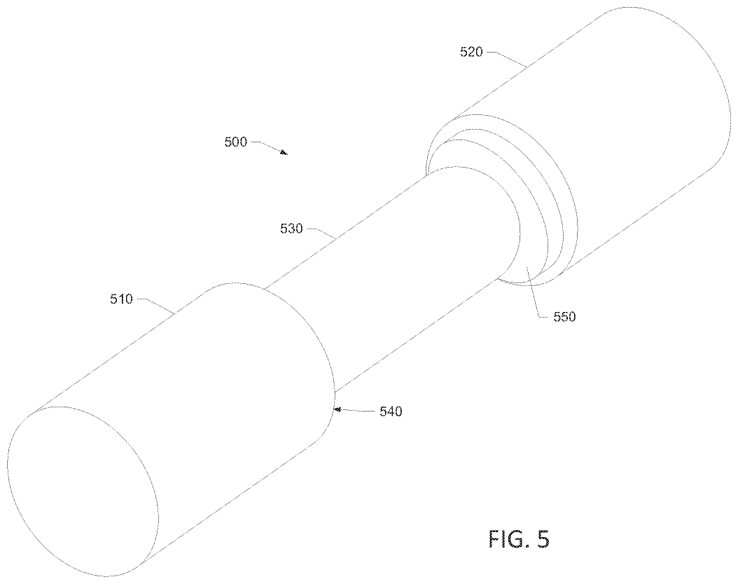

FIG. 5 illustrates a perspective view of a portion of a shank 500 of a boring tool (100, 200, 300) in accordance with an example embodiment. The shank 500 may further comprise a first end 510, a second end 520, a torsion release neck 530, a first transition 540 and a second transition 550. In some embodiments, the torsion release neck 530 may have a diameter of greater than or equal to 65%, and less than or equal to 95%, of a diameter of the first end 510 and the second end 520 of the shank 500. In some other embodiments, the torsion release neck 530 may have a diameter of greater than or equal to 80%, and less than or equal to 90%, of a diameter of the first end 510 and the second end 520 of the shank 500. In some embodiments, the first transition 540 and second transition 550 may be stepped connections between the torsion release neck and the first end 510 and the second end 520, respectively. In this regard, the diameter of the step in each of the first transition 540 and the second transition 550 may be greater than that of the torsion release neck 530 and less than that of the first end 510 and the second end 520 of the shank 500. In some embodiments, the shank 500 may have a total axial length of between about 1 inch to about 5 inches, and the torsion release neck 530 may have an axial length of between about 0.5 inches to about 1.5 inches. In one example embodiment, the torsion release neck 530 may be about 18 mm (0.7 inches) long.

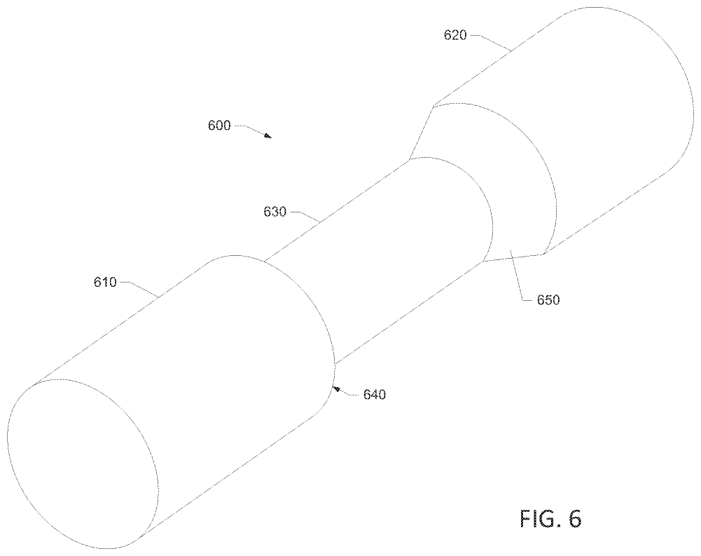

FIG. 6 illustrates a perspective view of a portion of a shank 600 of a boring tool (100, 200, 300) in accordance with an example embodiment. The shank 600 may further comprise a first end 610, a second end 620, a torsion release neck 630, a first transition 640 and a second transition 650. In some embodiments, the torsion release neck 630 may have a diameter of greater than or equal to 65%, and less than or equal to 95%, of a diameter of the first end 610 and the second end 620 of the shank 600. In some other embodiments, the torsion release neck 630 may have a diameter of greater than or equal to 80%, and less than or equal to 90%, of a diameter of the first end 610 and the second end 620 of the shank 600. In some embodiments, the first transition 640 and second transition 650 may be sloped connections between the torsion release neck and the first end 610 and the second end 620, respectively. In some embodiments, the shank 600 may have a total axial length of between about 1 inch to about 5 inches, and the torsion release neck 630 may have an axial length of between about 0.5 inches to about 1.5 inches. In one example embodiment, the torsion release neck 630 may be about 18 mm (0.7 inches) long.

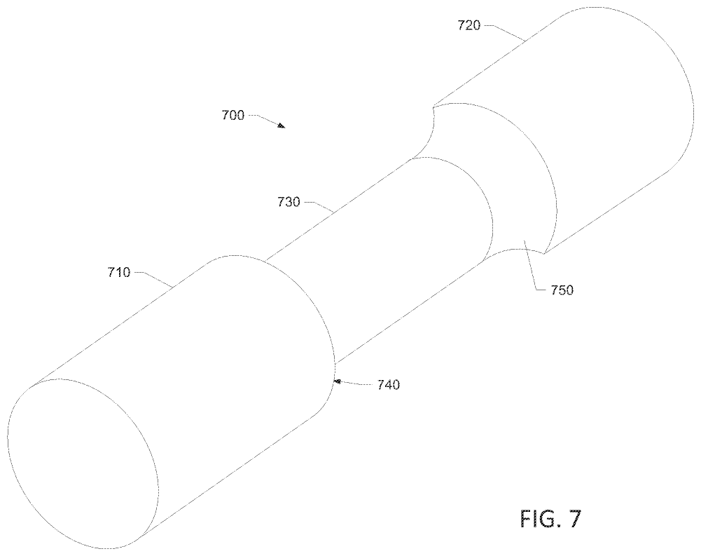

FIG. 7 illustrates a perspective view of a portion of a shank 700 of a boring tool (100, 200, 300) in accordance with an example embodiment. The shank 700 may further comprise a first end 710, a second end 720, a torsion release neck 730, a first transition 740 and a second transition 750. In some embodiments, the torsion release neck 730 may have a diameter of greater than or equal to 65%, and less than or equal to 95%, of a diameter of the first end 710 and the second end 720 of the shank 700. In some other embodiments, the torsion release neck 730 may have a diameter of greater than or equal to 80%, and less than or equal to 90%, of a diameter of the first end 710 and the second end 720 of the shank 700. In some embodiments, the first transition 740 and second transition 750 may be curved connections between the torsion release neck and the first end 710 and the second end 720, respectively. In some embodiments, the shank 700 may have a total axial length of between about 1 inch to about 5 inches, and the torsion release neck 730 may have an axial length of between about 0.5 inches to about 1.5 inches. In one example embodiment, the torsion release neck 730 may be about 18 mm (0.7 inches) long.

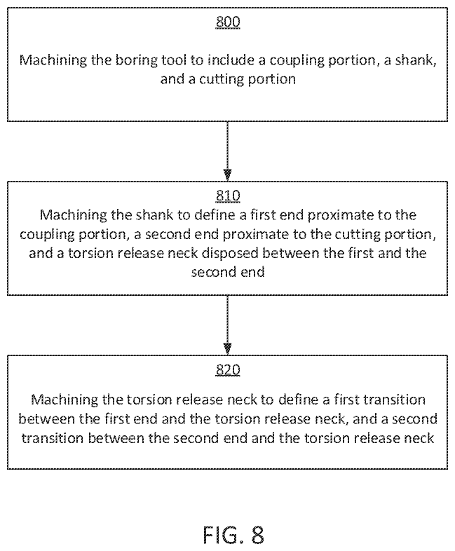

FIG. 8 illustrates a flowchart diagram of a method of machining a boring tool (100, 200, 300) in accordance with an example embodiment. The method is described in steps 800-820 of FIG. 8.

Some example embodiments may provide for a boring tool. The boring tool may include a coupling portion, a shank, a cutting portion and a torsion release neck. The shank may further include a first end, disposed towards the coupling portion, and a second end, disposed towards the cutting portion. A length of the torsion release neck of the boring tool may be about 0.5-1.5 inches long. A diameter of the torsion release neck may be 65%-95% of a diameter of the first end and the second end of the shank. A diameter of the torsion release neck may be 80%-90% of a diameter of the first end and the second end of the shank.

The boring tool of some embodiments may include additional features, modifications, augmentations and/or the like to achieve further objectives or enhance performance of the blade. The additional features, modifications, augmentations and/or the like may be added in any combination with each other. Below is a list of various additional features, modifications, and augmentations that can each be added individually or in any combination with each other. For example, the first or second transition may be a right angle. In an example embodiment, the first or second transition may be a stepped transition. In some cases, the first or second transition may be sloped. In an example embodiment, the first or second transition may be curved. In some cases, the boring tool may be an auger bit. In an example embodiment, the boring tool may be a spade bit. In some cases, the length of the torsion release neck of the boring tool may be about 0.5-1.5 inches long. In an example embodiment, the diameter of the torsion release neck may be 65%-95% of a diameter of the first end and the second end of the shank. In some cases, the diameter of the torsion release neck may be 80%-90% of a diameter of the first end and the second end of the shank. In an example embodiment, the boring tool may be driven by an impact driver. In some cases the torsion release neck is disposed closer to the first end of the shank. In an example embodiment, the torsion release neck is biased towards the second end of the shank.

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Moreover, although the foregoing descriptions and the associated drawings describe exemplary embodiments in the context of certain exemplary combinations of elements and/or functions, it should be appreciated that different combinations of elements and/or functions may be provided by alternative embodiments without departing from the scope of the appended claims. In this regard, for example, different combinations of elements and/or functions than those explicitly described above are also contemplated as may be set forth in some of the appended claims. In cases where advantages, benefits or solutions to problems are described herein, it should be appreciated that such advantages, benefits and/or solutions may be applicable to some example embodiments, but not necessarily all example embodiments. Thus, any advantages, benefits or solutions described herein should not be thought of as being critical, required or essential to all embodiments or to that which is claimed herein. Although specific terms are employed herein, they are used in a generic and descriptive sense only and not for purposes of limitation.

1. A boring tool comprising:
a coupling portion;
a shank; and
a cutting portion,
wherein the shank further comprises:
a first end proximate to the coupling portion,
a second end proximate to the cutting portion,
a torsion release neck disposed between the first end and the second end,
a first transition between the first end and the torsion release neck, and
a second transition between the second end and the torsion release neck, and
wherein the coupling portion is configured to be operably coupled to a driving device to rotate the boring tool.

2. The boring tool of claim 1, wherein the torsion release neck is disposed closer to the second end of the shank.

3. The boring tool of claim 2, wherein a diameter of the torsion release neck is greater than 60% of a diameter of the first end and the second end of the shank, and less than 95% of the diameter of the first end and the second end of the shank.

4. The boring tool of claim 3, wherein a diameter of the torsion release neck is greater than 80% of a diameter of the first end and the second end of the shank, and less than 90% of the diameter of the first end and the second end of the shank.

5. The boring tool of claim 1, wherein an axial length of the torsion release neck is greater than 0.5 inches and less than 1.5 inches.

6. The boring tool of claim 5, wherein the axial length of the torsion release neck is 18 mm.

7. The boring tool of claim 2, wherein the boring tool is an auger bit.

8. The boring tool of claim 2, wherein the boring tool is a spade bit.

9. The boring tool of claim 1, wherein the driving device is an impact driver.

10. The boring tool of claim 1, wherein the first transition and the second transition are right angles.

11. The boring tool of claim 1, wherein the first transition and the second transition are stepped.

12. The boring tool of claim 1, wherein the first transition and the second transition are sloped.

13. The boring tool of claim 1, wherein the first transition and the second transition are curved.

14. A method of making a boring tool, the method comprising:
machining the boring tool from a metallic bar stock such that the boring tool includes a coupling portion, a shank, and a cutting portion; and
machining the shank to define a first end proximate to the coupling portion, a second end proximate to the cutting portion, and a torsion release neck disposed between the first end and the second end; and
machining a first transition between the first end and the torsion release neck, and a second transition between the second end and the torsion release neck,
wherein the coupling portion is configured to be operably coupled to a driving device to rotate the boring tool.

15. The method of claim 14, wherein machining the torsion release neck comprises machining a diameter of the torsion release neck greater than 60% of a diameter of the first end and the second end of the shank, and less than 95% of the diameter of the first end and the second end of the shank.

16. The method of claim 14, wherein machining the torsion release neck comprises machining a diameter of the torsion release neck greater than 80% of a diameter of the first end and the second end of the shank, and less than 90% of the diameter of the first end and the second end of the shank.

17. The method of claim 14, wherein machining the shank comprises machining an axial length of the torsion release neck to greater than 0.5 inches and less than 1.5 inches.

18. The method of claim 14, wherein machining the shank comprises machining an axial length of the torsion release neck to 18 mm.

19. The method of claim 14, wherein machining the boring tool comprises machining an auger bit.

20. The method of claim 14, wherein machining the boring tool comprises machining a spade bit.
